(19) United States
(12) Patent Application Publication
(10) Pub. No.: US 2008/0091552 A1
(43) Pub. Date: Apr. 17, 2008

(54) Methods and systems for providing product information to a user

(76) Inventor: Eric F. Aas, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/540,876

(22) Filed: Sep. 29, 2006

(51) Int. Cl. G06Q 30/00

(52) U.S. Cl. 705/26

(57) ABSTRACT

A method of providing product information to a user includes obtaining a product identifier from the user that identifies a product, wherein the product identifier is transmitted with a user's mobile device to a server configured to conduct an electronic search for product information regarding the product; conducting the electronic search for product information regarding the product with the server; and reporting the product information to the user's mobile device. A system for providing product information to a user includes a server configured to receive a product identifier transmitted to the server by a user using a mobile device; and a connection between the server and one or more networks on which product information is stored, where the server is configured to conduct an electronic search for product information regarding a product identified by the product identifier and report the product information to the user's mobile device.

### BACKGROUND

When a consumer is out shopping for products that he or she needs, it can be difficult to compare pricing for a product from different vendors. Additionally, it may be difficult for the consumer to obtain as much information about a product as desired and to identify or assess possible alternatives to the product in question. The information about a product available to the consumer when at a particular vendor outlet is typically undesirably limited.

On the issue of pricing, a consumer can check a price for a product at a particular outlet. However, being at that outlet, the consumer will likely not be aware of how the product is priced at other potential outlets. The consumer can travel to or telephone other outlets to check on the pricing for a product. However, this process can be cumbersome, time-consuming and expensive. Consequently, the consumer is likely to simply pay the price being charged for the product at the outlet where the consumer is. As a result, the consumer may consistently pay more for products that is necessary.

### BRIEF DESCRIPTION OF THE DRAWINGS

The accompanying drawings illustrate various embodiments of the principles described herein and are a part of the specification. The illustrated embodiments are merely examples of the present invention and do not limit the scope of the claims.

FIG. 1 illustrates a system for obtaining comparative price and/or product information according to one exemplary embodiment of the principles described herein.

FIG. 2 is a flowchart illustrating a method of using the system illustrated in FIG. 1 to provide product and/or price information according to one exemplary embodiment of the principles described herein.

FIG. 3 is a flowchart illustrating an additional method of using the system illustrated in FIG. 1 to conduct a reverse auction for sale of a product according to one exemplary embodiment of the principles described herein.

FIG. 4 is a flowchart illustrating a business method for generating revenue by operation of the system illustrated in FIG. 1 according to one exemplary embodiment of the principles described herein.

Throughout the drawings, identical reference numbers designate similar, but not necessarily identical, elements.

### DETAILED DESCRIPTION

According to principles described herein, a consumer that is physically at a vendor outlet can quickly obtain product information, including comparative pricing, for a product using a wireless communication system. A product identifier, such as a bar code, that identifies the product of interest to the consumer is transmitted to a server that uses the product identifier to obtain any of comparative pricing information, additional product information or alternative product information. In some embodiments, the product identifier is collected for transmission using an imaging system.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

In the present specification and appended claims, the phrase “product information” will be broadly construed to include product pricing information, including comparative pricing, any additional information about the product and any information about potential alternative products. The additional information about a product or potential alternative product may include, but is not limited to, product specifications, suggested uses, suggested pricing, warranty information, product recalls or warnings, product construction materials, product options or features, or any other information regarding the product or alternative product.

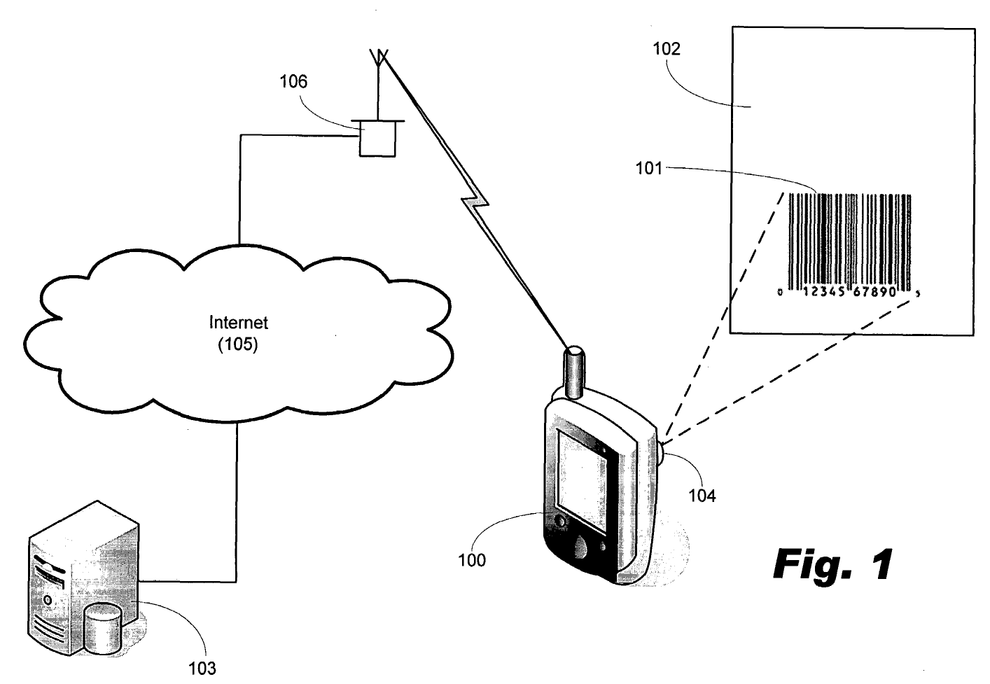

FIG. 1 illustrates a system for obtaining product information according to one exemplary embodiment of the principles described herein. As shown in FIG. 1, the disclosed system includes a wireless or mobile device (100). This mobile device (100) can be any device that has the capability of communicating with a wireless network or infrastructure. For example, the mobile device (100) may be a mobile phone, a mobile personal digital assistant (PDA), a smart phone or some other combination of mobile phone and PDA, a mobile palm-top computer, a laptop computer with an air card or other wireless communications capability, etc.

When a consumer is out shopping at retail or other vendor outlets and the consumer finds a product (102) of interest, the consumer transmits an identification of the product (102) using the wireless communications capability of the mobile device (100). For example, the mobile device (100) is used to transmit an identifier of the product (102) via a wireless network (106) and, in some embodiments, the internet (105) to a server (103). The wireless network (106) may be, for example, a wireless phone service network or other wireless infrastructure.

The server (103) uses the product identifier to conduct an on-line or electronic search using the internet (105) for vendors offering the product, sites with additional product information and/or alternative products. The wealth of product information available on-line, through the internet (105) or other computer networks can be extremely valuable to the consumer who is physically at a vendor outlet considering the purchase of a product. For example, for any given product, there are likely to be anywhere from several to many on-line vendors advertising pricing for that product. Consequently, the server (103) can collect a number of comparative prices for the product (102) identified by the user. This comparative pricing information can then be transmitted back to the mobile device (100) for display to the user. The user can then determine how competitive is the price for the product (102) at the vendor outlet where the user then is.

Additionally, the server (103) can use on-line resources, for example, the internet (105) to obtain additional information about the product (102) identified by the user. For example, the server (103) may access reviews of the product (102) by other consumers or professional product review services. The server (103) may access additional information about the product (102) from its manufacturer or other sources. Such additional product information may include, but is not limited to, product specifications, suggested uses, suggested pricing, warranty information, product recalls or warnings, product construction materials, product options or features, etc. This information can then be collected by the server (103) and transmitted back to the mobile device (100) for display to the user.

The server (103) may also use on-line resources, for example, the internet (105) to identify alternative products that may substitute for the product (102) identified by the user. Additionally, any of the types of product information mentioned above can also be obtained for any alternative product identified by the server (103). Then, suggested alternative products, including in some cases alternative product information, can be transmitted back to the mobile device (100) for display to the user.

While the user is physically located at a vendor outlet considering purchase of a product (102), the user typically does not have access to the wealth of information that might be available on-line about that product, including comparative pricing and alternative products. Using the system of FIG. 1, however, the user need only identified the product (102) in question and the information available on-line relevant to the decision to purchase the product (102) can be quickly and automatically made available to the user at the brick-and-mortar point of sale.

The product identifier used by the system of FIG. 1 can be any of a number of different devices that uniquely identify the product (102) in question. For example, the user may enter a product identifier such as a manufacturer, model number, Universal Price Code (UPC) number, stock-keeping unit (SKU) number or other product identifier into the mobile device (100) using, for example, a keypad, keyboard, touch-sensitive screen and stylus or other user input device. The product identifier is then transmitted to the server (103) for use as described above.

Alternatively, the mobile device (100) may include a camera or other imaging or optical scanning device. This imaging device (104) may be used to more rapidly and reliably capture the product identifier for transmission to server (103). In the example illustrated in FIG. 1, the product identifier (101) includes a bar code. This bar code or any other product identifier, including but not limited to those mentioned above, can be imaged using the imaging device (104).

This image of the identifier (101) can be transmitted as an image to the server (103). The server (103) can then process the image to identify the product (102) of interest. For example, the server (103) may use the image of a bar code to identify the product (102). Alternatively, the server (103) may use Optical Character Recognition (OCR) to extract alphanumeric data from the image that identifies the product (102), such as manufacturer name, model name or number, UPC or SKU number, etc. In either case, the server (103) is enabled to identify the product (102) of interest to the consumer and conduct an on-line search for additional information of use to the user.

Alternatively, the OCR used to extract alphanumeric data from the image to identify the product (102) may be conducted by the mobile device (100). The user may then, in some embodiments, review the extracted alphanumeric data to ensure that it has been recognized correctly by the OCR process. The extracted product identifier is then transmitted to the server (103) for use as described above.

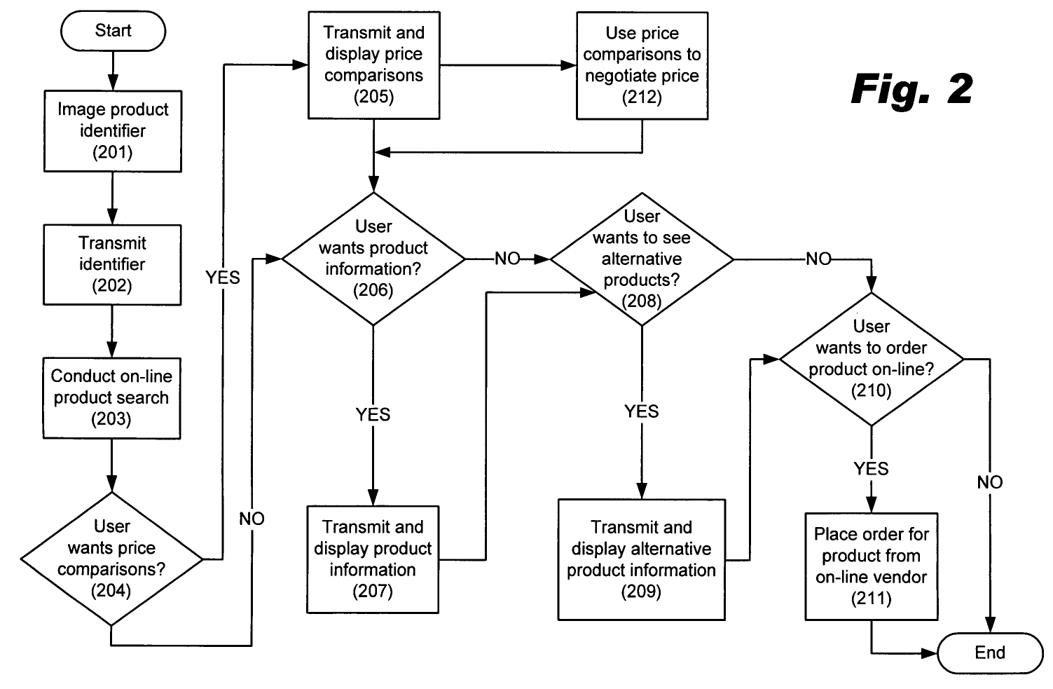

FIG. 2 is a flowchart illustrating a method of using the system illustrated in FIG. 1 to provide product and/or price information according to one exemplary embodiment of the principles described herein. As shown in FIG. 2 and as described above, the process begins when the user enters or images a product identifier (step 201). This product identifier is then transmitted (step 202) to the server (103) described above.

The server (103) uses the product identifier to conduct an automated on-line search (step 203) for information about the product identified. For example, the server (103) may collect comparative pricing information, additional information about the product and/or alternative product suggestions. The server (103) may user the internet and/or any other available databases or electronic resources to conduct this search and provide information to the user. In some examples, the operator of the server (103) may have access to or may prepare databases of relevant product information that are not on the internet or not publicly available. There is no limitation under the principles disclosed herein on the resources the server (103) uses to obtain product information for the system user.

As illustrated in FIG. 2, the user may have complete control over what information is obtained or delivered by the server (103). The user may define what type of information is desired when transmitting the product identifier to the server (103) or may respond to and accept different types of information as the server (103) returns search results.

For example, the user may desire to see price comparisons for the product (102) in question (determination 204). If so, the server (103) can transmit and the mobile device (100) can display or otherwise report the prices being charged by other vendors for the product (102). (Step 205). For example, the mobile device (100) may display the comparative pricing or other product information on a screen or display device, including a touch-sensitive screen. Alternatively, the mobile device (100) may print or audibly report the product information. Any means of reporting the product information to the user available to the mobile device (100) may be used.

The comparative price information may include information identifying both the alternative vendors offering the product as well as the asking price from each such vendor. The report from the server (103) may also take into account shipping and handling or other charges such that the user can determine the total cost for obtaining the product (102) from any of the vendors listed as compared to simply buying the product from the vendor outlet where the user then is.

Once the user has the comparative pricing information, the user can then determine how competitive the price for the product is at the vendor outlet where the user then is. Additionally, the user may, in some examples, use the competitive pricing information provided by the server (103) to negotiate a similar or better price from the vendor outlet where the user then is. (Step 212).

If the user only desires comparative pricing information, no further action need occur. However, the user may also desire or may initially or solely desire additional information about the product in question (102). (Determination 206). If the user wants additional product information, the additional product information about the product (102) that the server (103) has obtained can be transmitted to and reported by the mobile device (100). (Step 207). For example, the mobile device (100) may display the additional product information for the user.

The user may also be interested in information identifying alternative products that may substitute for the product in question (102). (Determination 208). If so, the server (103) can transmit and the mobile device (100) can report information obtained from the server's on-line search that identifies and, in some cases, further describes, products that may serve as substitutes for the product (102) about which the user is inquiring. (Step 209).

Again, the user may selectively request or accept one, some or all of the various different types of information identified above. Once the user has obtained the information desired about the product (102), the user may be interested in placing an order for the product (102) from one of the competing vendors identified by the server (103). (Determination 210). If so, the user can transmit an order with the mobile device (100) to the server (103) or directly to the identified vendor for the product (102).

In some examples, the user may have established an account with the server (103) before or when initially using the server (103). This account may include such information about the user as shipping address, credit card or other billing information and any other information needed to place an order with an on-line vendor on behalf of the user. When the user transmits an instruction to order a product (step 211), the server (103) can use the information from the user's account to place an order for the product with an on-line vendor selected by the user (step 211).

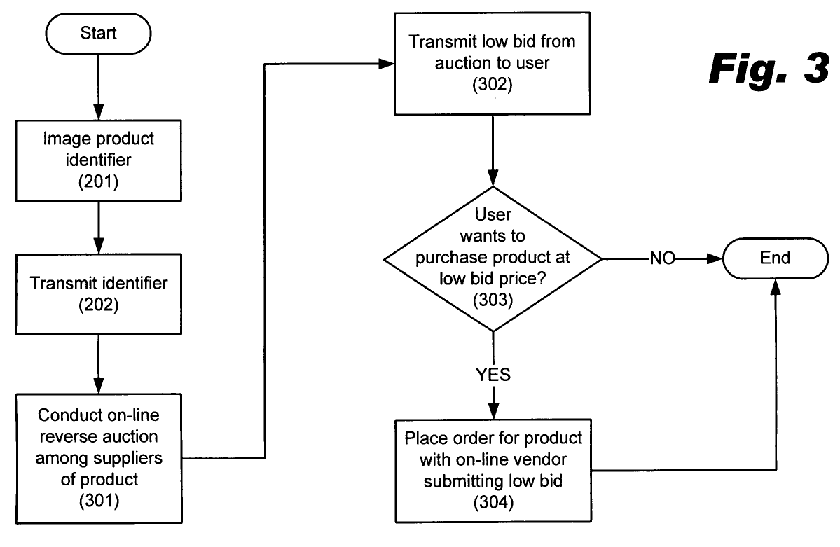

FIG. 3 is a flowchart illustrating an additional method of using the system illustrated in FIG. 1 to conduct a reverse auction for sale of a product according to one exemplary embodiment of the principles described herein. Another service that can be performed by the server (103) is conducting a reverse auction among on-line vendors who wish to sell the product (102) to the user.

As shown in FIG. 3, the user inputs a product identifier, for example by data entry or imaging, and transmits the product identifier to the server (103). (Steps 201 and 202). The server (103) then uses the product identifier to positively identify the product the user desires. The server (103) then conducts an on-line reverse auction among competing vendors who wish to sell the product to the user. (Step 301).

This reverse auction may, in some embodiments, include the server (103) electronically advising vendors of the product and quantity of the product desired by the user based on the received product identifier (101) and related information. The vendors can then return to the server (103) a bid or price quote at which that vendor will sell the desired product in the desired quantity to the user. This may include shipping and handling or other charges such that the bid constitutes a total price to the user for the product or products desired.

Once the auction has concluded, the server (103) can transmit the results to the user via the mobile device (100). (Step 302). This may include transmitting all the bids received or may include only transmitting the low bid from the auction. (Step 302).

The user can then decide whether to accept the low or other bid from the auction (determination 303). This decision may be made with reference to the immediacy of purchasing the product from a vendor location where the user already is as compared to any potential price savings generated by the auction with the delay involved of having the product shipped.

If the user decides to purchase the product from the auction winner or any auction bidder, the user can transmit an instruction to the server (103) using the mobile device (100). The server (103) will accordingly place an order for the product from the designated vendor using, for example, information in a corresponding user account as described above. (Step 304).

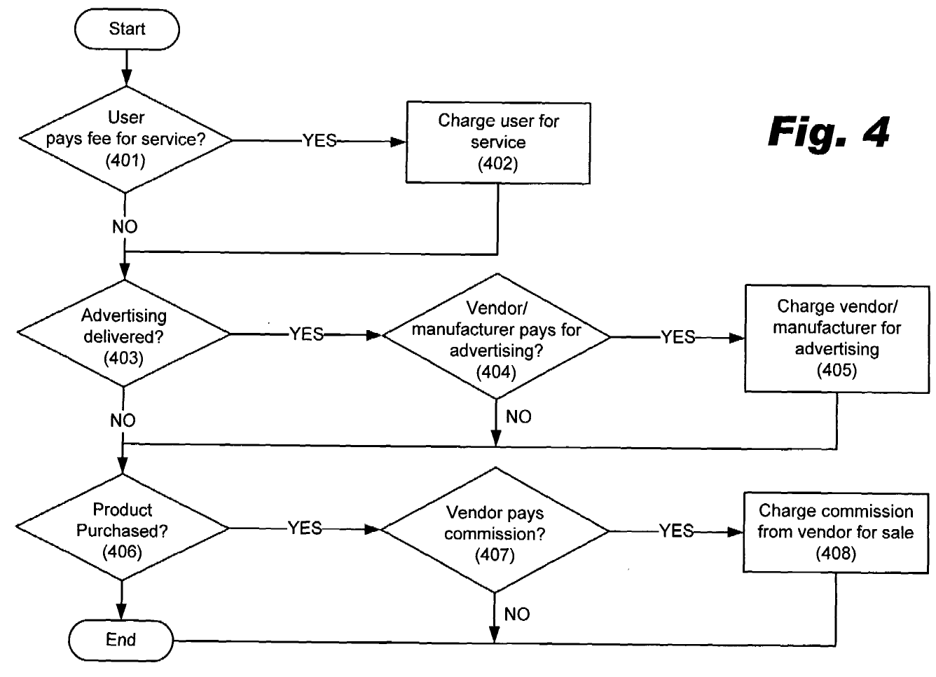

FIG. 4 is a flowchart illustrating a business method for generating revenue by operation of the system illustrated in FIG. 1 according to one exemplary embodiment of the principles described herein. The server (103) described above can be profitably operated as a business enterprise using one or more of the following business models and others. As used herein and in the appended claims, the term “server operator” or “operator” will refer broadly to any person or business enterprise that owns, leases or operates a server (e.g., 103) performing any of the services described herein.

As shown in FIG. 4, the system of FIG. 1 can be operated based on a charge to the user for the service provided. For example, the user can subscribe to the services provided by the server (103) as described above by establishing an account with the server operator. This account may include the details described above as well as a method of billing the user for the service. For example, the user may have charges made to a credit card or may receive an invoice for using the services of the server (103). The charges may be a flat fee or may be based on the amount of use the user makes of the services of the server (103). The billing may be made on a periodic basis or may occur as frequently as the user uses the service.

If the user is using the system under some agreement to pay for the services rendered (determination 401), the user is charged for the service (step 402). This is one way in which the operator of the system can generate revenue from operating the server (103).

Alternatively or additionally, the operator of the server (103) may charge manufacturers and/or vendors for advertising distributed to a user. For example, the information about the queried product or alternative products provided to the user may include advertising promoting that product or a particular vendor of that product. If such advertising is delivered (determination 403), the vendor or manufacturer may have an agreement with the operator of the server (103) to compensate the operator of the server (103) for distributing that advertising (determination 404).

If such an advertising arrangement exists (determination 404), the operator of the server (103) can charge the vendor or manufacturer for distributing the advertising (step 405). This is another way in which the operator of the system can generate revenue from operating the server (103).

Alternatively or additionally, the operator of the server (103) may charge a commission for sales of products that are made to the users of the server (103). As shown in FIG. 4 and as described above, the provision of information about comparative pricing and alternative vendors and products to the user, including the conduct of an on-line reverse auction, may result in the user instructing the server (103) to place an order for a product or products with a vendor that the server (103) has identified. (Determination 406).

If such an order is placed, the vendor may be under agreement or induced to pay a commission to the operator of the server (103). (Determination 407). If that is the case, the operator of the server (103) then charges a commission to the vendor for the sale of the product (step 408). This commission may be a flat fee or a percentage of the value of the product order, as arranged between the vendor and operator of the server (103).

The preceding description has been presented only to illustrate and describe embodiments of the invention. It is not intended to be exhaustive or to limit the invention to any precise form disclosed. Many modifications and variations are possible in light of the above teaching.

What is claimed is:

1. A method of providing product information to a user, said method comprising:
obtaining a product identifier from said user that identifies a product, wherein said product identifier is transmitted with a user's mobile device to a server configured to conduct an electronic search for product information regarding said product;
conducting said electronic search for product information regarding said product with said server; and
reporting said product information to said user's mobile device.

2. The method of claim 1, wherein obtaining said product identifier comprises imaging a product identifier with said mobile device.

3. The method of claim 2, wherein obtaining said product identifier further comprises optical character recognition performed on an image taken with said mobile device.

4. The method of claim 1, wherein said product identifier comprises a bar code.

5. The method of claim 1, wherein said product information comprises comparative pricing information.

6. The method of claim 1, wherein said product information comprises alternative product information.

7. The method of claim 1, further comprising placing an order for said product on behalf of said user based on an instruction transmitted from said user's mobile device.

8. The method of claim 1, wherein said conducting said electronic search comprises conducting a reverse on-line auction among vendors bidding to sell said product to said user.

9. The method of claim 1, further comprising charging a fee to said user for conducting said electronic search and reporting said product information.

10. The method of claim 1, wherein said product information comprises product advertising and said method further comprises charging a vendor or manufacturer for delivering said product advertising to said user.

11. The method of claim 7, further comprising charging a commission from a vendor with whom said order is placed.

12. A system for providing product information to a user, said system comprising:
a server configured to receive a product identifier transmitted to said server by a user using a mobile device; and
a connection between said server and one or more networks on which product information is stored;
said server further configured to conduct an electronic search for product information regarding a product identified by said product identifier and report said product information to said user's mobile device.

13. The system of claim 12, wherein said mobile device comprises a mobile telephone or personal digital assistant.

14. The system of claim 12, wherein said mobile device comprises an imaging system for imaging said product identifier for use by said server.

15. The system of claim 14, further comprising an optical character recognition function for extracting data from an image of said product identifier taken with said mobile device.

16. The system of claim 12, wherein said product information comprises comparative pricing information.

17. The system of claim 12, wherein said product information comprises alternative product information.

18. The system of claim 12, wherein said server is further configured to place an order for said product on behalf of said user based on an instruction transmitted from said user's mobile device.

19. The system of claim 12, wherein said server is further configured to conduct a reverse on-line auction among vendors bidding to sell said product to said user.

20. A system for providing product information to a user, said system comprising:
means for obtaining a product identifier from said user that identifies a product, wherein said product identifier is transmitted with a user's mobile device to a server configured to conduct an electronic search for product information regarding said product;
means for conducting said electronic search for product information regarding said product with said server; and
means for reporting said product information to said user's mobile device.
